(19) United States
(12) Patent Application Publication
(10) Pub. No.: US 2017/0162352 A1
(43) Pub. Date: Jun. 8, 2017

(54) DEVICE FOR DRIVING AN ELECTROMECHANICAL COMPONENT

(71) Applicant: Robert Bosch GmbH, Stuttgart (DE)

(72) Inventors: Peter Braun, Buehlertal (DE); Michael Rummel, Achern-Oensbach (DE); Michael Forscht, Appenweier (DE); Zakarya Bamohamed, Strasbourg (FR)

(21) Appl. No.: 15/039,111

(22) PCT Filed: Nov. 21, 2014
(86) PCT No.: PCT/EP2014/075287

§ 371 Date: May 25, 2016

(30) Foreign Application Priority Data
Nov. 27, 2013 (DE) 10 2013 224 300.6

(51) Int. Cl. H01H 47/32

(52) U.S. Cl. CPC H01H 47/325

(57) ABSTRACT

The invention relates to a device (100) for driving an electromechanical component (200), having: an integrated circuit (10) for driving a semiconductor element having an H-bridge driver apparatus (20); and an interface apparatus (30), by means of which the H-bridge driver apparatus (20) can be used for the electromechanical component (200), wherein, by means of the interface apparatus (30), a temporal operating behavior of a semiconductor component for the integrated circuit (10) can be simulated.

### BACKGROUND OF THE INVENTION

The invention relates to a device for driving an electromechanical component. The invention further relates to a method for driving an electromechanical component.

Application specific integrated components are known, which have an integrated H-bridge driver apparatus, by means of which components of the semiconductor technology can be actuated. In this way, MOSFETs, IGBTs (insulated gate bipolar transistor) and bipolar transistors can, for example, be actuated by means of the H-bridge driver apparatuses.

### SUMMARY OF THE INVENTION

An aim underlying the invention is to provide a simplified device for actuating electromechanical components by means of an integrated circuit.

According to a first aspect, the aim of the invention is met by means of a device for driving an electromechanical component, having:
an integrated circuit for driving a semiconductor element having an H-bridge driver apparatus; and
an interface apparatus, by means of which the H-bridge driver apparatus can be used for the electromechanical component, wherein, by means of the interface apparatus, a temporal operating behavior of a semiconductor component for the integrated circuit can be simulated.

As a result, a driving of different components is advantageously facilitated by means of a circuit design of the integrated circuit which can be universally used. Hence, a use of cost effective integrated circuits which are manufactured in large quantities is possible. A simple and quick adaptation of the integrated circuit to the component type to be driven in each case is thereby made possible. In this way, a smart ASIC is implemented which, e.g., monitors a complete protective functionality of an electromechanical component.

According to a second aspect, the aim of the invention is met by means of a method for driving an electromechanical component using an integrated circuit, which is provided for semiconductor elements and has an H-bridge driver apparatus, comprising the following steps:
ascertaining an electrical voltage of a relay coil of the electromechanical component;
signaling the electrical voltage of the relay coil to the integrated circuit;
switching a relay contact of the electromechanical component;
simulated feedback of an operating behavior of a semiconductor component to the integrated circuit; and
cancelling an activation of the electromechanical component if the voltage of the relay coil does not have the intended value thereof after a defined period of time and the relay contact was not properly switched.

One preferred embodiment of the device according to the invention is characterized in that a functionality of a relay contact of the electromechanical component can be determined by means of a delay unit of the interface apparatus. In this way, it can be ensured that the relay contact functions properly. In particular, a false detection of a short circuit in the relay contact can be prevented.

One preferred embodiment of the device according to the invention is characterized in that an electrical voltage of a relay coil and a relay contact of the electromechanical component can be checked. As a result, a comprehensive and reliable check of a proper functionality of the electromechanical component can be carried out. In the event that one of the aforementioned elements does not yield the desired test result, the electromechanical component is not activated.

Provision is made in a further preferred embodiment of the device according to the invention for the H-bridge driver apparatus to be arranged internally or externally of the integrated circuit. In this way, a flexible circuit design is supported which facilitates a quick and simple switching of driver circuits.

A further preferred embodiment of the device according to the invention is characterized in that threshold values at a signal input can be set for checking a functionality of the relay contact. In this way, different electromechanical components can be individually adapted to the integrated circuit. A usability of the integrated circuit is thereby advantageously very flexible.

A further preferred embodiment of the device according to the invention is characterized in that a high-side stage or a low-side stage of the H-bridge driver apparatus can be used to drive the electromechanical component. In this way, the H-bridge driver apparatus can be used very flexibly.

Provision is made in an advantageous modification to the method according to the invention for the voltage of the relay coil to be ascertained and the relay contact to be checked via a single signal input. This supports an economical use of connection pins of the integrated circuit, whereby an effective use of circuit resources is made possible.

### BRIEF DESCRIPTION OF THE DRAWINGS

The invention is described below in detail having further features and advantages with the aid of a plurality of figures. In so doing, all of the described or depicted features form by themselves or in any desired combination the subject matter of the invention independently of the summarization thereof in the patent claims or the dependence thereof on related claims as well as independently of the formulation thereof or respectively the depiction thereof in the description or in the figures. The figures are primarily intended to illustrate the principles that are essential to the invention.

In the drawings:

FIG. 1 shows a basic block wiring diagram of one embodiment of the device according to the invention;

FIG. 2 shows a basic detailed circuit diagram of a conventional electromechanical relay;

FIG. 3 shows a basic detailed circuit diagram of one embodiment of the device according to the invention; and

FIG. 4 shows a basic flow diagram of one embodiment of the method according to the invention.

### DETAILED DESCRIPTION

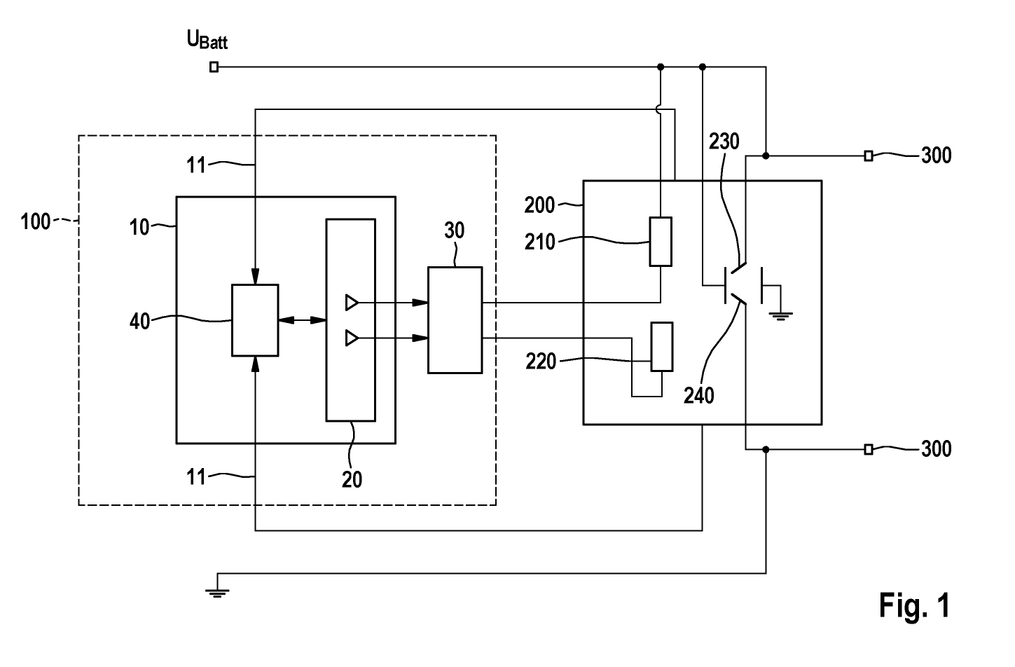

FIG. 1 shows a basic block wiring diagram of an embodiment of the device 100 according to the invention for driving an electromechanical component 200. The electromechanical component 200 is, for example, designed as an electromechanical relay. The device 100 comprises an application-specific integrated circuit 10 (ASIC) which integrally comprises an H-bridge driver apparatus 20 for driving semiconductor elements, preferably MOSFETs. The semiconductor elements to be driven can also be designed as IGBTs, bipolar transistors, etc. The integrated circuit 10 comprises a computing apparatus 40, e.g. in the form of a microcontroller. Further elements and apparatuses of the integrated circuit 10 which are known per se are not essential to the invention and are thus neither depicted here nor explained in detail.

Relay contacts 230, 240 and relay coils 210, 220 of the electromechanical component 200 can be monitored or respectively controlled by means of the H-bridge driver apparatus 20 in combination with an interface apparatus 30. To this end, sensing lines 11 are supplied to the computing apparatus 40, which transmit a current state of the relay contacts 230, 240 or respectively an electrical voltage of the relay coils 210, 220. Both aforementioned elements are checked, wherein, in the event that one of said elements does not function properly, a non-functionality of the entire electromechanical component 200 is detected and the electromechanical component 200 is not activated.

By means of motor contacts 300, an electric motor (e.g. a drive motor of an electric window lifter of a motor vehicle, not depicted) can be connected via the electromechanical component 200 to an electrical supply voltage U_{Batt}, wherein the motor is only then switched on if the relay coils 210, 220 as well as the relay contacts 230, 240 of the electromechanical component 200 function properly.

A presence of a semiconductor element is simulated for the computing apparatus 40 by means of the interface apparatus 30, wherein a characteristic differentiation criterion with respect to an electromechanical component 200 is that a semiconductor component is switched on substantially faster or respectively can transmit a feedback signal to the computing apparatus 40. Hence, only a very short time period for a diagnosis is generally available for components of the semiconductor technology. Said diagnosis typically occurs within approximately 1 μs to approximately 40 μs.

According to the invention, this check is carried out in a time delayed manner by means of an electronic circuitry expansion. This is based on the fact that a typical electromechanical relay requires approximately 2 ms to approximately 3 ms in order to react to switching signals, which can be caused by a bouncing of the relay contacts.

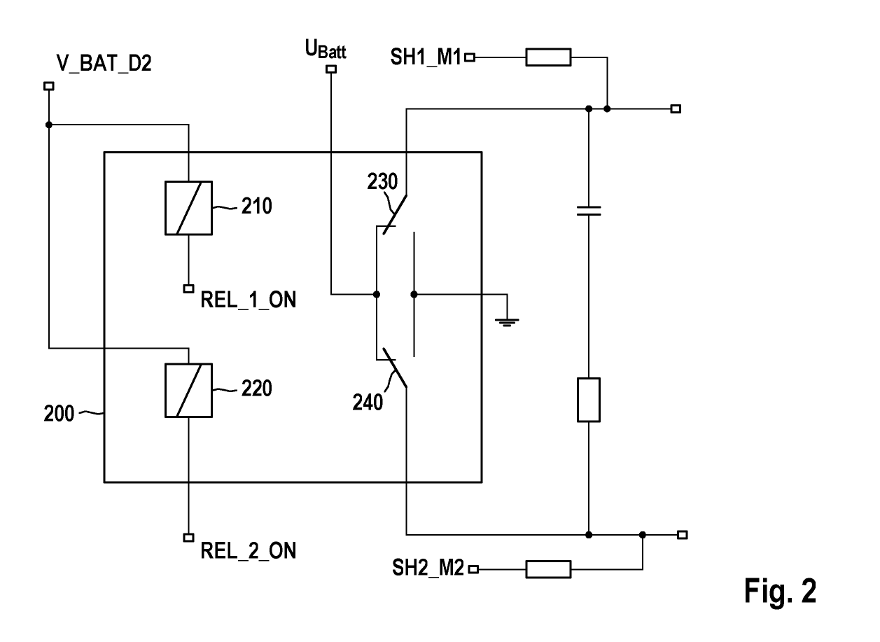

FIG. 2 shows an internal circuit of a conventional electromechanical component 200, which is designed as a double relay having two relays in one housing. A relay coil 210 and a relay contact 230 of a first relay as well as a relay coil 220 and a relay contact 240 of a second relay can be seen. The operation of the device 100 according to the invention is described below with reference to the first relay, an operation of the second relay being identical to that of the first relay.

The relay coil 210 can be switched on or respectively a current state of the relay coil 210 is transmitted to the computing apparatus 40 via a connection REL_1_ON. The relay coil 210 is connected to an electrical voltage V_BAT_D2 (e.g. 13V) via a reverse-connect protection diode (not depicted). A current state of the relay contact 230 can be reported to the computing apparatus 40 via a connection SH1_M1.

A non-activated state of the relay is depicted, wherein the relay contact 230 permanently lies on the potential of the supply voltage U_{Batt}, whereby the signaling connections SH1 and SH1_M1 lie at U_{Batt}.

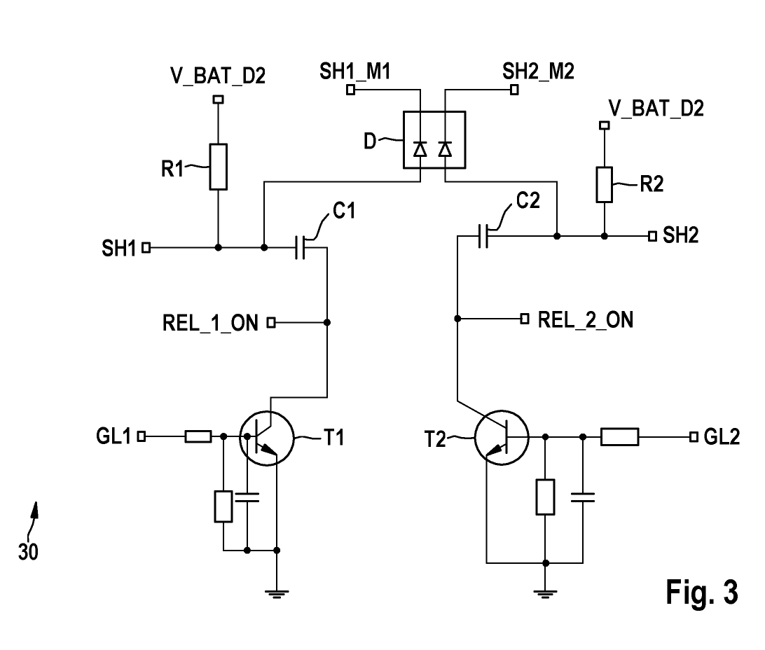

FIG. 3 shows a basic detailed circuit diagram of an interface apparatus 30 in one embodiment of the device 100 according to the invention. A substantially symmetric design of the interface apparatus 30 can be seen, wherein respectively a half of the circuit part of the interface apparatus 30 is used for one of the two relay coils of the double relay of FIG. 2. An operation of the two circuit parts is identical in this case.

The relay contact 230 is switched on or respectively activated via a first transistor T1 by means of a connection GL1 provided by the H-bridge driver apparatus 20. For this purpose, a high signal must be supplied to the connection GL1. An electrical coil voltage of the relay coil 210 is signaled to the input SH1 to the computing apparatus 40 via the connection SH1_M1 via a double diode D and an RC element comprising a resistor R1 (e.g. 100 kΩ) and a capacitor C1 (e.g. 10 μF).

As a result of switching on the relay contact 230, an electromagnetic field is generated by the relay coil 210, said electromagnetic field exerting a force effect on the relay contact 230, whereby the relay contact 230 is switched to the ground potential.

A typical short circuit detection for components using semiconductor technology should be carried out within the short time periods mentioned above. Because, however, in the present case an electromechanical component in the form of a relay, which is significantly slower in comparison to the semiconductor element, is to be actuated, provision is made for an error-free relay contact to be simulated for the present.

To this end, the RC element R₁C₁ is charged with a defined time constant, wherein, shortly thereafter, a low state is reported via the connection SH1. As a result, it is “simulated” that the relay is OK because C1 is discharged at the switching point T1 and the ground potential is overcoupled after SH1. Due to the time constant of the RC element, the signal at SH1 subsequently approaches the high state with a time delay if the relay contact 230 was not switched to ground potential as a reaction to the activation. This means that the relay is not OK but “sticks”.

If, however, the relay contact 230 was switched as a reaction to the activation to ground potential, the diode D becomes conductive and permanently holds the signal SHI to ground potential, which means that the relay is OK.

In the event that the relay contact 230 “sticks”, i.e. does not assume ground potential but remains “stuck” to U_{Batt}, the signal SH1 is further charged according to the time constant of the RC element R₁C₁ until a predefined threshold value is reached, wherein an error of the relay contact 230 is reported when said threshold value has been exceeded. As a result, the relay is no longer activated or respectively is switched off due to the detected non-functionality of the relay contact 230 in order to prevent a movement of the connected electric motor.

As a result, time is therefore provided or respectively gained by means of the RC element R₁C₁ in order to properly detect a status of the “slow” relay contact 230.

In the event that the RC element R₁C₁ and the diode D are not present, the signal at SH1 would in fact detect an error of the relay contact 230 because a high signal would be immediately outputted, which however results only on account of the inertia of the relay contact 230 and does not represent an actual error. An authentic check of a status of the relay contact 230 can therefore not be implemented with the RC element R₁C₁ and the diode D without the delay concept according to the invention.

As a result, it is taken into account that the relay contact 230 reacts systemically rather slowly to the actuation signal of the transistor T1. Thus, a quick feedback of a supposedly switched relay contact is simulated although the relay cannot at all feedback such a current state so quickly due to the inertia thereof. As a result, the computing apparatus 40 is prevented from detecting a short circuit of the relay contact.

In this way, an ASIC used for driving semiconductor components can advantageously be used for driving and checking an electromechanical relay.

In this way, a use of a standard ASIC is advantageously facilitated for a varied use for driving technologically different elements. In this way, a cost effective implementation of circuit arrangements is advantageously supported.

A use of pins of the ASIC can likewise be managed in a substantially more flexible manner because the H-bridge driver apparatus is provided exclusively for driving the elements. Due to the fact that H-bridge drivers are used, other pins of the ASIC can be used elsewhere. As a result, this means a gain of usable pins of the ASIC. In order to monitor an electromechanical relay, advantageously only a single pin in the integrated circuit 10 in the form of SH1 or respectively SH2 is required.

In addition, advantageously no software modification is required within the circuit 10 in order to be able to drive a variety of different components by means of the integrated circuit 10.

The high-side stage as well as the low-side stage of the aforementioned H-bridge driver circuit 30 can advantageously be used.

In an embodiment of the device not depicted in the figures, it is also conceivable that the depicted interface apparatus 20 is disposed externally of the circuit 10. In this way, the aforementioned standard ASIC can be used for a variety of purposes by means of a simple use of the aforementioned interface apparatus 20.

In contrast to the conventional solution, which provides different ASIC designs in accordance with a power technology of the components to be driven, an ASIC which can be manufactured in large quantities and is therefore cost effective can be used by means of the invention.

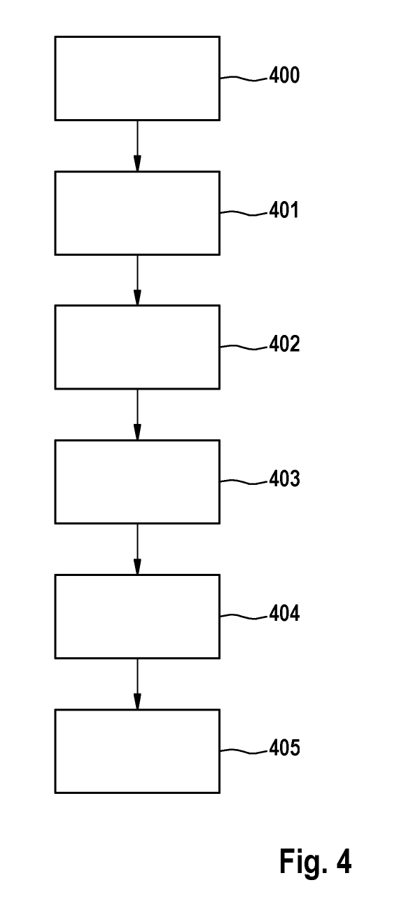

FIG. 4 shows a principle of a flow diagram of an embodiment of the method according to the invention.

In a first step 400, an electrical voltage of a relay coil of the electromechanical component 200 is ascertained.

In a second step 401, a signaling of the electrical voltage of the relay coil to the integrated circuit 10 is carried out.

In a third step 402, a switching of a relay contact of the electromechanical component 200 is carried out.

In a fourth step 403, a simulated feedback of an operating behavior of a semiconductor component to the integrated circuit is carried out.

In a fifth step 404, a current state of the relay contact 230 is signaled to the integrated circuit.

Finally in a sixth step 405, an activation of the electromechanical component 200 is cancelled if the voltage of the relay coil does not have the intended value thereof after a defined period of time (e.g. after several milliseconds) and the relay contact 230 was not properly switched.

It goes without saying that the circuits shown are only exemplary embodiments, wherein the inventive concept can also be implemented using a variety of other circuit constellations. A logic can also optionally be inversely designed as previously described.

The person skilled in the art will be able to modify the disclosed features or combine them with one another without deviating from the gist of the invention.

1. A device (100) for driving an electromechanical component (200), the device (100) comprising:
an integrated circuit (10) for driving a semiconductor element having an H-bridge driver apparatus (20); and
an interface (30), by which the H-bridge driver apparatus (20) can be used with the electromechanical component (200),
wherein, the interface apparatus (30) is able to simulate a temporal operating behavior of a semiconductor component for the integrated circuit (10).

2. The device (100) according to claim 1, characterized in that a functionality of a relay contact (230) of the electromechanical component (200) can be ascertained using a delay apparatus (R₁C₁) of the interface apparatus (30).

3. The device (100) according to claim 1, characterized in that an electrical voltage of a relay coil (210) and a relay contact (220) of the electromechanical component (200) can be tested.

4. The device (100) according to claim 1, characterized in that the H-bridge driver apparatus (20) is disposed internally of the integrated circuit (10).

5. The device (100) according to claim 1, characterized in that threshold values at a signal input are set to check a functionality of the relay contact (220).

6. The device (100) according to claim 1, characterized in that a high-side stage of the H-bridge driver apparatus (20) is used to drive the electromechanical component (200).

7. A method for driving an electromechanical component (200) by an integrated circuit (10) which comprises an H-bridge driver apparatus (20), the method comprising:
ascertaining an electrical voltage of a relay coil (210) of the electromechanical component (200);
signaling the electrical voltage of the relay coil (210) to the integrated circuit (10);
switching a relay contact (230) of the electromechanical component (200);
simulating feedback of an operating behavior of a semiconductor element to the integrated circuit (10);
signaling a current state of the relay contact (230) to the integrated circuit; and
cancelling an activation of the electromechanical component (200) if the voltage of the relay coil (210) does not have the intended value thereof after a defined period of time and the relay contact (230) was not properly switched.

8. The method according to claim 7, wherein the voltage of the relay coil (210) is ascertained and the relay contact is checked via a single signal input (SH1) of the integrated circuit (10).

9. A use of an integrated circuit (10) having an H-bridge driver apparatus (20) for the semiconductor technology for driving an electromechanical component (200).

10. The use of an integrated circuit (10) according to claim 9, wherein the integrated circuit (10) provides protective functionality of electromechanical relays.

11. A non-transitory computer readable medium having a computer program including program code for carrying out the method according to claim 7 when said computer program is run on a computing apparatus (40).

12. The device (100) according to claim 1, characterized in that the H-bridge driver apparatus (20) is disposed externally of the integrated circuit (10).

13. The device (100) according to claim 1, characterized in that a low-side stage of the H-bridge driver apparatus (20) is used to drive the electromechanical component (200).
